(19) United States
(12) Patent Application Publication
(10) Pub. No.: US 2004/0075204 A1
(43) Pub. Date: Apr. 22, 2004

(54) Spring element

(76) Inventors: Josef Heidemann, Lembruch (DE); Kai Bruning, Sulingen (DE); Josef Dultmeyer, Steinfeld (DE)

Correspondence Address: Basf Corporation, Patent Department, 1609 Biddle Avenue, Wyandotte, MI, 48192, US

(21) Appl. No.: 10/470,248

(22) PCT Filed: Jan. 25, 2002
(86) PCT No.: PCT/EP02/00769

(30) Foreign Application Priority Data
Feb. 7, 2001 (DE) 10105791.1

(51) Int. Cl. F16F 1/40

(52) U.S. Cl. 267/294; 267/139

(57) ABSTRACT

The invention relates to spring elements based on at least two elastic moldings (i) and (ii), connected to one another by at least one connector (iii).

The invention relates to spring elements based on at least two elastic moldings (i) and (ii) connected to one another by at least one connector (iii). The invention further relates to automobiles comprising the spring elements of the invention.

Elements with a spring function and produced from polyurethane elastomers are used in automobiles, for example within the chassis, and are well known. They are used in particular in motor vehicles as vibration dampers or spring elements. These spring elements nowadays have the function of linking the shock absorber to the bodywork, or of decoupling the vibration from the helical steel springs, or else of giving the chassis suspension a progressive spring characteristic. Elastic linkages of this type improve travel comfort an provide a high level of travel safety.

Since the characteristics and properties of each model of automobile are very different, the spring elements have to be adapted individually to the various models in order to achieve the ideal match to each chassis. Examples of factors taken into account when developing the spring elements are the weight of the vehicle, the chassis of the specific model, the shock absorbers and helical steel springs intended for use, and also the springing characteristics desired. In addition to this, each solution has to be matched to the particular design of the automobile.

For the abovementioned reasons, known solutions for the design of specific spring elements cannot generally be adopted for new models of automobile. For each new model of automobile developed it is necessary to develop a new shape for the spring element, meeting the specific requirements of the model.

It is an object of the present invention to develop a design for a spring element with a level of variability which has not hitherto been achieved with respect to springing characteristics and dimension at full compression. The method of achieving this individual adjustment of the spring elements should be simple and rapid. In addition, a spring element developed for a specific new model of automobile should give very good acoustic decoupling of the helical steel spring, and also produce a specific progressive spring characteristic for the chassis suspension, complying with the specific requirements placed upon this model in particular and providing very good travel comfort and excellent travel safety.

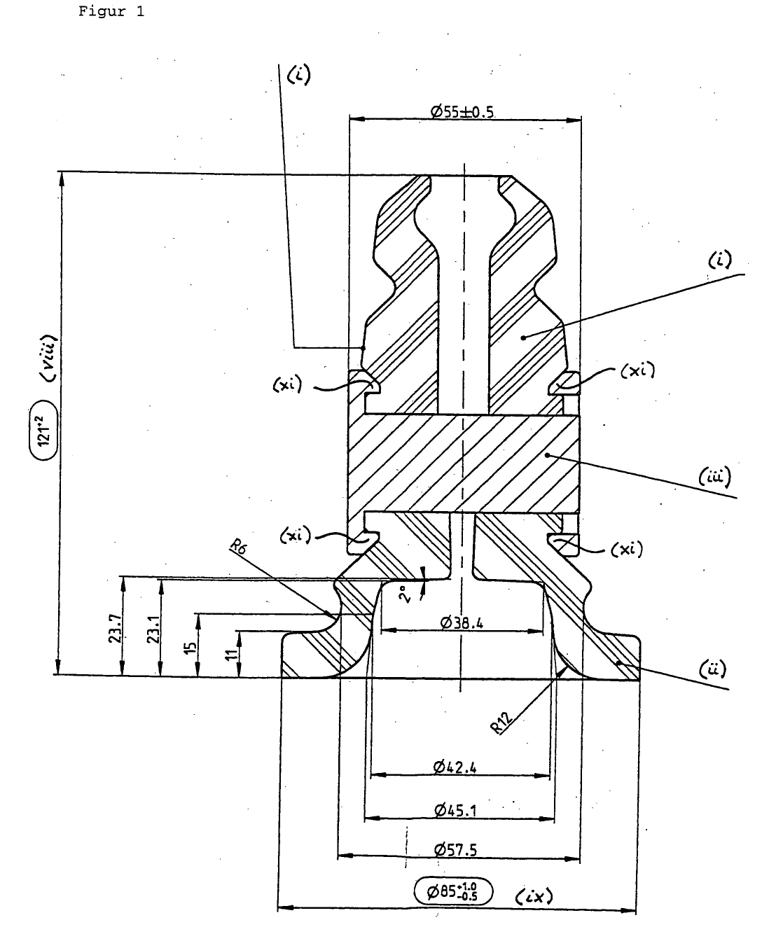

We have found that this object is achieved, as have the other objects mentioned, by the spring elements described at the outset. FIG. 1 shows a spring element of the invention based on two elastic moldings (i) and (ii) and on a connector (iii). The dimensions are given in [mm]. For the purposes of the present invention, elastic moldings are moldings based on an elastic material, such as rubber or known synthetic elastomers, for example the preferred polyisocyanate polyaddition products.

The advantages of the present invention are to be found in the fact that the connector (iii), which is preferably inelastic, can combine elastic moldings with different properties and shapes. Since spring elements have hitherto comprised one elastic molding, variability is markedly increased by this inventive combination of more than one elastic molding, preferably two elastic moldings. The principles of the technical teaching of the present invention also permit, for example, more than one connector (iii) to be used to connect more than two elastic moldings to one another, for example three elastic moldings between which there are two connectors. The teaching of the invention permits rapid and simple individual adaptation of the springing characteristic of the entire spring element. It is also possible to vary the dimension at maximum compression as desired for any given volume to be filled by the spring element, since the proportion by volume of the connector (iii) can be varied as desired. For the purposes of the present invention, the dimension at maximum compression is the residual height of the elastic molding under maximum load (compression). Since there is preferably some degree of enclosure of (i) and (ii) by (iii), i.e. (iii) preferably encloses some of the periphery of (i) and (ii), even if the same materials are used for (i) and (ii) their spring characteristic can be altered, further increasing variability.

The elastic moldings are usually based on known synthetic elastomers, such as rubber, and preferably polyisocyanate polyaddition products, in particular preferably on cellular polyurethane elastomers which may, where appropriate, contain polyurea structures, and in particular on cellular polyurethane elastomers with density to DIN 53420 of from 200 to 1100 kg/m³, preferably from 300 to 800 kg/m³, tensile strength to DIN 53571 of ≧2 N/mm², preferably from 2 to 8 N/mm², elongation to DIN 53571 of ≧300%, preferably from 300 to 700%, and tear propagation resistance to DIN 53515 of ≧8 N/mm, preferably from 8 to 25 N/mm.

The elastic moldings present in the spring element, preferably two elastic moldings (i) and (ii), preferably have different densities to DIN 53420. This permits the achievement of spring characteristics which have not been achieved hitherto.

It is particularly preferable for two moldings present in the spring element to differ in each of the parameters given above. The preparation of polyurethane elastomers is described at a later point in this specification. Variation of the starting components, their proportions by weight, and the compression in the mold allows moldings to be obtained which have different properties. This is well known to the skilled worker.

The connector (iii) may be based on well-known materials, such as plastics or metals, e.g. polyethylene, polypropylene, polyoxymethylene, PVC, ABS, polystyrene, thermoplastic polyurethane, aluminum, steel, copper, iron. (iii) is preferably based on compact plastics or metal, particularly preferably on inelastic materials.

Well-known methods of linking may be used to connect (i) and (ii) to (iii). Examples of methods used to connect the elastic moldings to (iii) are positive interlocking, bonding, frictional interlocking, and combinations of these methods. One connection of this type (positive-interlock linkage) is shown diagrammatically in FIG. 1. The connector has rims (xi) behind which the elastic moldings (i) and (ii) are clamped.

(i), (ii), and (iii) preferably have a hole through which, for example, the connecting rod of the chassis mounting can pass. (ii) may preferably be used for linking the spring element to a helical spring.

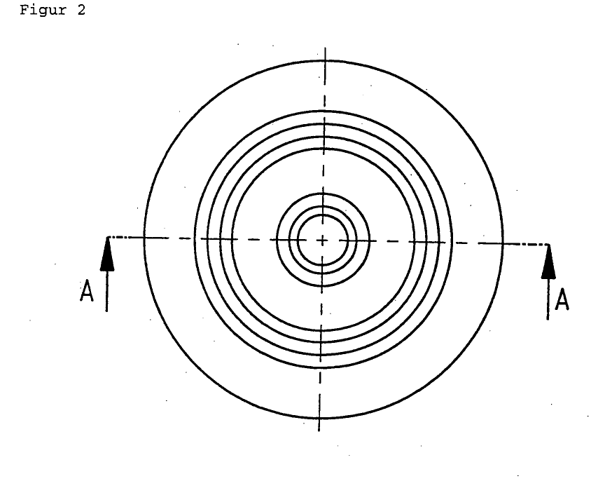

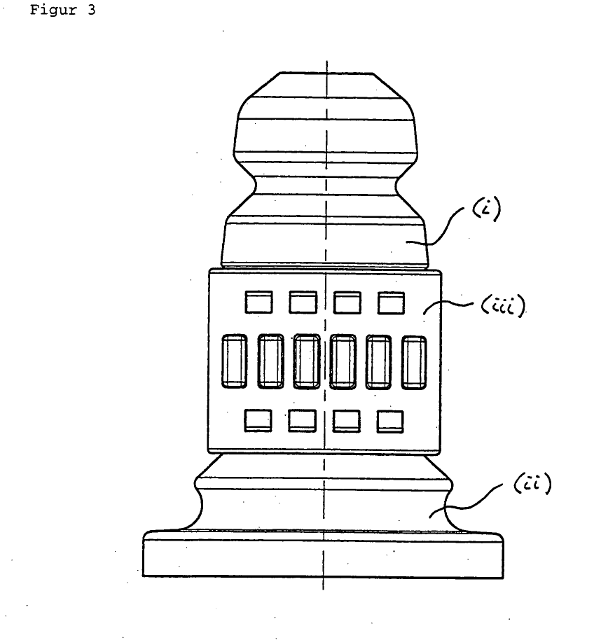

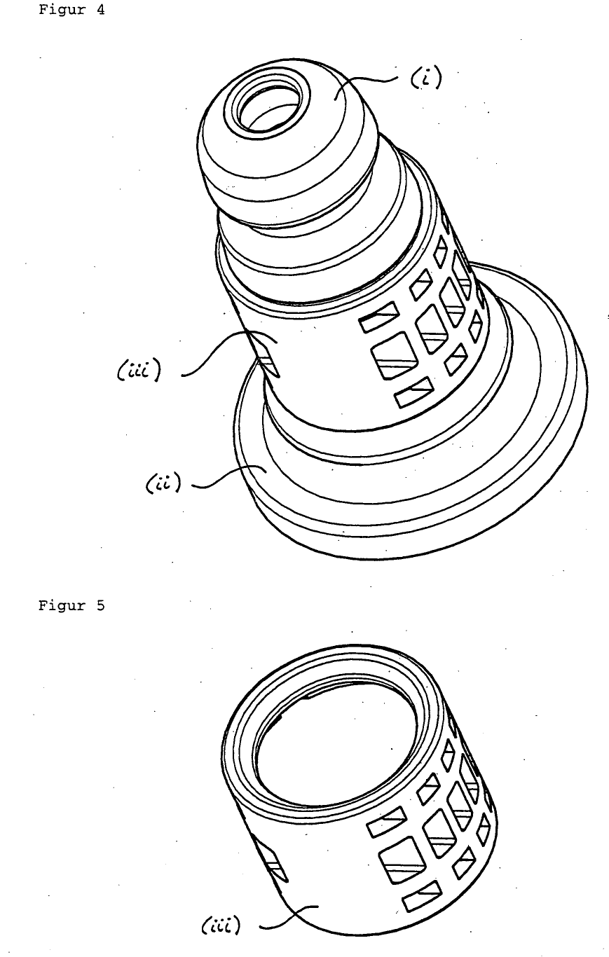

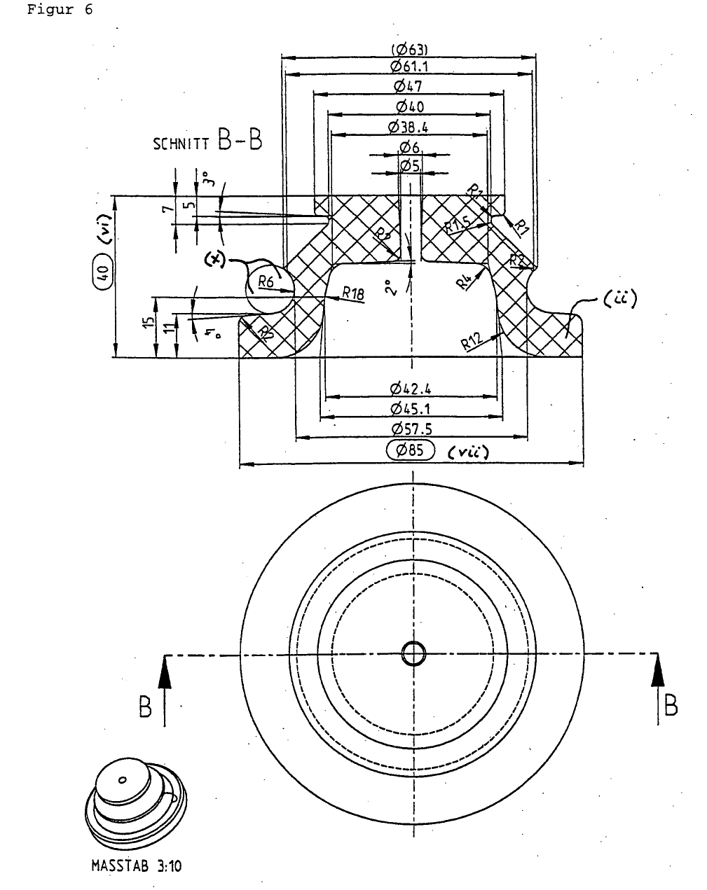

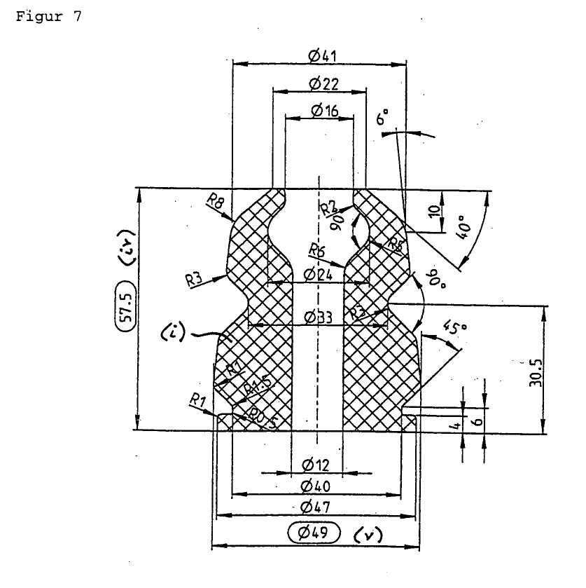

FIG. 1 shows an example of a spring element developed and optimized for a specific application. FIG. 2 shows a plan view of the spring element, while FIGS. 3 and 4 show other views. FIG. 5 is a diagram of the connector (iii), while FIG. 6 gives the dimensions for the elastic molding (ii) and FIG. 7 gives those for the elastic molding (i). As can be seen from the figures, the preferred spring element has for (i) a height (iv) of 57.5 mm and a maximum diameter (v) of 49 mm, for (ii) a height (vi) of 40 mm and a maximum diameter (vii) of 85 mm, and for the entire spring element a height (viii) of from 119 to 123 mm and a maximum diameter (ix) of from 84 to 86 mm. (x) indicates the end of the helical spring in contact with (ii). (x) may be connected to (ii) by positive-interlock linkage. An example of the use of the spring element depicted is therefore use as a supplementary spring for the helical spring or as a means of decoupling the helical steel spring. The lengths given in the figures have the unit [mm].

Besides the material of which they are made, another specific factor affecting the function of the spring elements is their three-dimensional design. The shape of the spring elements places definite restrictions on the displacements of the helical steel springs, and brings about a controled improvement in the resultant stability of the traveling automobile, as required by the customer. This three-dimensional shape of the spring element therefore has to be developed individually for each model of automobile.

The damping elements of the invention are preferably based on elastomers based on polyisocyanate polyaddition products, such as polyurethanes and/or polyureas, e.g. polyurethane elastomers, which, where appropriate, may contain polyurea structures. The elastomers are preferably microcellular elastomers based on polyisocyanate polyaddition products, preferably with cells of diameter from 0.01 to 0.5 mm, particularly preferably from 0.01 to 0.15 mm. The elastomers particularly preferably have the physical properties described at the outset. Elastomers based on polyisocyanate polyaddition products and their preparation are well known and have been widely described, for example in EP-A 62 835, EP-A 36 994, EP-A 250 969, DE-A 195 48 770 and DE-A 195 48 771.

They are customarily prepared by reacting isocyanates with compounds reactive toward isocyanates.

The elastomers based on cellular polyisocyanate polyaddition products are usually prepared in a mold in which the reactive starting components are reacted with one another. The molds used here may be molds which are general and usual, for example metal molds, the shape of which ensures that the spring element has the three-dimensional shape according to the invention.

The polyisocyanate polyaddition products may be prepared by well known processes, for example by using the following starting materials in a single- or two-stage process:

(a) isocyanate,

(b) compounds reactive toward isocyanates,

(c) water, and, where appropriate,

(d) catalysts,

(e) blowing agents, and/or

(f) auxiliaries and/or additives, for example polysiloxanes and/or fatty acid sulfonates.

The surface temperature of the inner wall of the mold is usually from 40 to 95° C., preferably from 50 to 90° C.

The moldings are advantageously produced using an NCO/OH ratio of from 0.85 to 1.20, the heated starting components being mixed and the amounts of these corresponding to the desired density of the molding being introduced into a heated mold, preferably one capable of leakproof sealing.

After from 5 to 60 minutes, the moldings have cured and can therefore be removed from the mold.

The amount of the reaction mixture introduced into the mold is usually judged so as to give the resultant moldings the abovementioned density.

The starting components are usually introduced into the mold at from 15 to 120° C., preferably from 30 to 110° C. The degree of compaction for producing the moldings is from 1.1 to 8, preferably from 2 to 6.

The cellular polyisocyanate polyaddition products are usefully produced by the one-shot process with the aid of low-pressure technology, or in particular by reactive injection molding (RIM) in open molds, or preferably in closed molds. The reaction is in particular carried out with compaction in a closed mold. Examples of descriptions of reactive injection molding are those of H. Piechota and H. Röhr in “Integralschaumstoffe”, Carl Hanser-Verlag, Munich, Vienna 1975; D. J. Prepelka and J. L. Wharton in Journal of Cellular Plastics, March/April 1975, pp. 87-98 and U. Knipp in Journal of Cellular Plastics, March/April 1973, pp. 76-84.

If use is made of a mixing chamber with more than one feed nozzle, the starting components may be introduced individually and mixed intimately within the mixing chamber. It has proven advantageous to operate by the two-component process.

In one particularly advantageous embodiment, using a two-stage process, a prepolymer containing NCO groups is first prepared. To this end, component (b) is reacted with (a) in excess, usually at from 80° C. to 160° C., preferably from 110° C. to 150° C. The reaction time is judged so as to achieve the theoretical NCO content.

According to the invention, therefore, the moldings are preferably produced in a two-stage process, by using the first stage to react (a) with (b) to prepare a prepolymer having isocyanate groups, and using the second stage to react this prepolymer, in a mold, with a crosslinker component comprising, where appropriate, the other components described at the outset.

To improve the ease of removal of the vibration damper from the mold it has proven advantageous to coat the inner surfaces of the mold, at least at the start of a production run, with conventional external mold-release agents, such as those based on wax or on silicone, or in particular with aqueous soap solutions.

Depending on the size and geometry of the molding, average mold residence times are from 5 to 60 minutes.

After production of the moldings in the mold, the moldings can preferably be annealed for from 1 to 48 hours, usually at from 70 to 120° C.

The following may be said concerning the starting components well known to the skilled worker for preparing the polyisocyanate polyaddition products:

The isocyanates (a) used may be well-known (cyclo)aliphatic and/or aromatic polyisocyanates. Compounds particularly suitable for producing the composite elements of the invention are aromatic diisocyanates, preferably-diphenylmethane 2,2′-, 2,4′- and/or 4,4′-diisocyanate (MDI), naphthylene 1,5-diisocyanate (NDI), tolylene 2,4- and/or 2,6-diisocyanate (TDI), 3,3′-dimethylbiphenyl diisocyanate, 1,2-diphenylethane diisocyanate and phenylene diisocyanate, and/or aliphatic isocyanates, such as dodecane 1,12-diisocyanate, 2-ethylbutane 1,4-diisocyanate, 2-methylpentane 1,5-diisocyanate, butane 1,4-diisocyanate, and preferably hexamethylene 1,6-diisocyanate, and/or cycloaliphatic diisocyanates, e.g. cyclohexane 1,3- and 1,4-diisocyanate, hexahydrotolylene 2,4- and 2,6-diisocyanate, dicyclohexylmethane 4,4′-, 2,4′- and 2,2′-diisocyanate, preferably 1-isocyanato-3,3,5-trimethyl-5-isocyanatomethylcyclohexane and/or polyisocyanates, such as polyphenyl polymethylene polyisocyanates. The isocyanates may be used in the form of the pure compound, in mixtures, and/or in a modified form, for example in the form of uretdiones, isocyanurates, allophanates or biurets, preferably in the form of particular adipic acid, with polyoxymethylene glycols whose number-average molecular weight is from 162 to 600, and, where appropriate, with aliphatic diols, in particular 1,4-butanediol. Other suitable polyoxytetramethylene glycols containing ester groups are polycondensates formed from the polycondensation of ε-caprolactone.

Suitable polyoxyalkylene glycols containing carbonate groups, substantively polyoxytetramethylene glycols, are polycondensates made from these compounds using alkyl carbonates or using aryl carbonates or phosgene.

Examples of embodiments of component (b) are given in DE-A-195 48 771, page 6, lines 26 to 59.

In addition to the components described above which are reactive toward isocyanates, use may also be made of (b1) low-molecular-weight chain extenders and/or low-molecular-weight crosslinkers with a molecular weight below 500, preferably from 60 to 499, for example those selected from the group consisting of the di- and trihydric alcohols, di- to tetrahydric polyoxyalkylene polyols, and the alkyl-substituted aromatic diamines, or from mixtures made from at least two of the chain extenders and/or crosslinkers mentioned.

Examples of compounds which may be used as (b1) are alkanediols having from 2 to 12 carbon atoms, preferably 2, 4, or 6 carbon atoms, e.g. ethanediol, 1,3-propanediol, 1,5-pentanediol, 1,6-hexanediol, 1,7-heptanediol, 1,8-octanediol, 1,9-nonanediol, 1,10-decanediol, and preferably 1,4-butanediol, dialkylene glycols having from 4 to 8 carbon atoms, e.g. diethylene glycol and dipropylene glycol, and/or di- to tetrahydric polyoxyalkylene polyols.

However, other suitable compounds are branched-chain and/or unsaturated alkanediols, usually those having not more than 12 carbon atoms, e.g. 1,2-propanediol, 2-methyl- or 2,2-dimethyl-1,3-propanediol, 2-butyl-2-ethyl-1,3-propanediol, but-2-ene-1,4-diol, and but-2-yne-1,4-diol, diesters of terephthalic acid with glycols having from 2 to 4 carbon atoms, e.g. the bis(ethylene glycol) or bis(1,4-butanediol) esters of terephthalic acid, hydroxyalkylene ethers of hydroquinone or of resorcinol, e.g. 1,4-di(β-hydroxyethyl)hydroquinone or 1,3-di(β-hydroxyethyl)resorcinol, alkanolamines having from 2 to 12 carbon atoms, e.g. ethanolamine, 2-aminopropanol, and reaction products containing urethane groups and isocyanate groups, known as isocyanate prepolymers. Preference is given to the use of unmodified or modified diphenylmethane 2,2′-, 2,4′- and/or 4,4′-diisocyanate (MDI), naphthylene 1,5-diisocyanate (NDI), 3,3′-dimethylbiphenyl diisocyanate, tolylene 2,4- and/or 2,6-diisocyanate (TDI), and/or mixtures of these isocyanates.

The compounds (b) used which are reactive toward isocyanates may be well-known polyhydroxyl compounds, preferably those having a functionality of from 2 to 3 and preferably a molecular weight of from 60 to 6000, particularly preferably from 500 to 6000, in particular from 800 to 5000. Compounds preferably used as (b) are polyether polyols, polyester polyalcohols, and/or polycarbonates containing hydroxyl groups.

Compounds preferably used as (b) are polyester polyalcohols, also termed polyester polyols below. One way of preparing suitable polyester polyols is from dicarboxylic acids having from 2 to 12 carbon atoms and dihydric alcohols. Examples of dicarboxylic acids which may be used are: aliphatic dicarboxylic acids, such as succinic acid, glutaric acid, adipic acid, suberic acid, azelaic acid and sebacic acid, and aromatic dicarboxylic acids, such as phthalic acid, isophthalic acid, and terephthalic acid. The dicarboxylic acids may be used individually or as a mixture. To prepare the polyester polyols it can, where appropriate, be advantageous to use the corresponding carboxylic acid derivatives instead of the carboxylic acid, for example carboxylic esters having from 1 to 4 carbon atoms in the alcohol moiety, carboxylic anhydrides, or carbonyl chlorides. Examples of dihydric alcohols are glycols having from 2 to 16 carbon atoms, preferably from 2 to 6 carbon atoms, e.g. ethylene glycol, diethylene glycol, 1,4-butanediol, 1,5-pentanediol, 1,6-hexanediol, 1,10-decanediol, 2-methyl-1,3-propanediol, 2,2-dimethyl-1,3-propanediol, 1,3-propanediol, and dipropylene glycol. Depending on the properties desired, the dihydric alcohols may be used alone or, where appropriate, in mixtures with one another.

Polyester polyols whose use is preferred are ethanediol polyadipates, 1,4-butanediol polyadipates, ethanediol butanediol polyadipates, 1,6-hexanediol neopentyl glycol polyadipates, 1,6-hexanediol 1,4-butanediol polyadipates, 2-methyl-1,3-propanediol 1,4-butanediol polyadipates, and/or polycaprolactones.

Suitable polyoxyalkylene glycols containing ester groups, substantively polyoxytetramethylene glycols, are polycondensates made from organic, preferably aliphatic, dicarboxylic acids, in 3-amino-2,2-dimethylpropanol, and N-alkyldialkanolamines, e.g. N-methyl- and N-ethyldiethanolamine.

Examples which may be mentioned of higher-functionality crosslinkers (b1) are trihydric alcohols and higher-functionality alcohols, e.g. glycerol, trimethylolpropane, pentaerythritol and trihydroxycyclohexanes, and also trialkanolamines, e.g. triethanolamine.

Chain extenders which may be used are: alkyl-substituted aromatic polyamines, preferably those with molecular weights from 122 to 400, in particular primary aromatic diamines which have at least one alkyl substituent positioned ortho to the amino groups and reducing the reactivity of the amino group by steric hindrance, these being liquid at room temperature and at least to some extent, but preferably completely, miscible with the relatively high-molecular-weight, preferably at least bifunctional compounds (b) under the processing conditions used.

The following compounds readily obtainable industrially may be used to produce the moldings of the invention: 1,3,5-triethyl-2,4-phenylenediamine, 1-methyl-3,5-diethyl-2,4-phenylenediamine, mixtures made from 1-methyl-3,5-diethyl-2,4- and -2,6-phenylenediamines, known as DETDA, isomeric mixtures made from 3,3′-di- or 3,3′,5,5′-tetraalkyl-substituted 4,4′-diaminodiphenylmethanes having from 1 to 4 carbon atoms in the alkyl radical, in particular 3,3′,5,5′-tetraalkyl-substituted 4,4′-diaminodiphenylmethanes containing methyl, ethyl or isopropyl radicals, or else mixtures made from the tetraalkyl-substituted 4,4′-diaminodiphenylmethanes mentioned and DETDA.

To achieve specific mechanical properties, it can also be useful to use the alkyl-substituted aromatic polyamines in a mixture with the abovementioned low-molecular-weight polyhydric alcohols, preferably di- and/or trihydric alcohols, or dialkylene glycols.

However, it is preferable for no aromatic diamines to be used. The products of the invention are therefore preferably prepared in the absence of aromatic diamines.

The preparation of the cellular polyisocyanate polyaddition products may preferably be carried out in the presence of water (c). The water acts both as crosslinker, with formation of urea groups, and also, due to its reaction with isocyanate groups, as blowing agent with formation of carbon dioxide. Since it has this double function it is listed in this text separately from (e) and (b). Water is therefore by definition not present in component (b) or (e), but by definition is exclusively listed as (c).

The amounts of water which may appropriately be used are from 0.01 to 5% by weight, preferably from 0.3 to 3.0% by weight, based on the weight of component (b). Some or all of the water may be added in the form of the aqueous solutions of the sulfonated fatty acids.

To accelerate the reaction, well-known catalysts (d) may be added to the reaction mixture either during the preparation of a prepolymer or else, where appropriate, during the reaction of a prepolymer with a crosslinker component. The catalysts (d) may be added individually or else mixed with one another. These are preferably organometallic compounds, such as tin(II) salts of organic carboxylic acids, e.g. tin(II) dioctoate, tin(II) dilaurate, dibutyltin diacetate or dibutyltin dilaurate, or tertiary amines, such as tetramethylethylenediamine, N-methylmorpholine, diethylbenzylamine, triethylamine, dimethylcyclohexylamine, diazabicyclooctane, N,N′-dimethylpiperazine, N-methyl-N′-(4-N-dimethylamino)butylpiperazine, N,N,N′,N″,N″-pentamethyldiethylenediamine, or the like.

Other catalysts which may be used are: amidines, e.g. 2,3-dimethyl-3,4,5,6-tetrahydropyrimidine, tris(dialkylaminoalkyl)-s-hexahydrotriazines, in particular tris(N,N-dimethylaminopropyl)-s-hexahydrotriazine, tetraalkylammonium hydroxides, e.g. tetramethylammonium hydroxide, alkali metal hydroxides, e.g. sodium hydroxide, and alkali metal alcoholates, e.g. sodium methylate and potassium isopropylate, and also alkali metal salts of long-chain fatty acids having from 10 to 20 carbon atoms and, where appropriate, having lateral OH groups.

Depending on the reactivity to be achieved, the amounts used of the catalysts (d) are from 0.001 to 0.5% by weight, based on the prepolymer.

Where appropriate, conventional blowing agents (e) may be used in preparing the polyurethane. Examples of those which are suitable are low-boiling liquids which evaporate due to the heat generated in the polyaddition reaction. Suitable liquids are those inert toward the organic polyisocyanate and having boiling points below 100° C. Examples of liquids of this type whose use is preferred are halogenated, preferably fluorinated, hydrocarbons, e.g. methylene chloride and dichloromonofluoromethane, perfluorinated or partially fluorinated hydrocarbons, e.g. trifluoromethane, difluoromethane, difluoroethane, tetrafluoroethane and heptafluoropropane, hydrocarbons, e.g. n-butane, isobutane, n-pentane and isopentane, and also the industrial mixtures of these hydrocarbons, propane, propylene, hexane, heptane, cyclobutane, cyclopentane and cyclohexane, dialkyl ethers, e.g. dimethyl ether, diethyl ether and furan, carboxylic esters, e.g. methyl formate and ethyl formate, ketones, e.g. acetone, and/or fluorinated and/or perfluorinated tertiary alkylamines, e.g. perfluorodimethylisopropylamine. It is also possible to use mixtures of these low-boiling liquids with one another and/or with other substituted or unsubstituted hydrocarbons.

The most useful amount of low-boiling liquid for producing these cellular elastic moldings from elastomers containing urea groups depends on the density desired, and also on the amount of the water preferably used concomitantly. Amounts of from 1 to 15% by weight, preferably from 2 to 11% by weight, based on the weight of component (b) generally give satisfactory results. It is particularly preferable for water (c) to be the only blowing agent used.

According to the invention, auxiliaries and additives (f) may be used in producing the moldings. Examples of those included here are well-known surface-active substances, hydrolysis stabilizers, fillers, antioxidants, cell regulators, flame retardants, and also dyes. Compounds which may be used as surface-active substances are those which serve to promote the homogenization of the starting materials and, where appropriate, are also suitable for regulating the cell structure. Mention may be made, for example, of compounds additional to the emulsifiers of the invention and having an emulsifying action, such as the amine salts of fatty acids, e.g. diethylammonium oleate, diethanolammonium stearate and diethanolammonium ricinoleate, and salts of sulfonic acids, e.g. the alkali metal or ammonium salts of dodecylbenzene- or dinaphthylmethanedisulfonic acid. Use may also be made of foam stabilizers, e.g. oxethylated alkylphenols, oxethylated fatty alcohols, paraffin oils, castor oil esters, ricinoleic esters, Turkis red oil, and groundnut oil, and cell regulators, such as paraffins and fatty alcohols. Other substances which may be used as (f) are polysiloxanes and/or fatty acid sulfonates. The polysiloxanes used may be well-known compounds, such as polymethylsiloxanes, polydimethylsiloxanes, and/or polyoxyalkylene-silicone copolymers. The polysiloxanes preferably have a viscosity of from 20 to 2000 mPas at 25° C.

The fatty acid sulfonates used may be well-known sulfonated fatty acids which are also available commercially. Sulfonated castor oil is preferably used as fatty acid sulfonate.

The amounts usually used of the surface-active substances are from 0.01 to 5 parts by weight, based on 100 parts by weight of component (b).

We claim:

1. A spring element based on at least two elastic moldings (i) and (ii) connected to one another via at least one connector (iii).

2. A spring element as claimed in claim 1, wherein the elastic moldings are based on polyisocyanate polyaddition products.

3. A spring element as claimed in claim 1, wherein the elastic moldings are based on cellular polyurethane elastomers.

4. A spring element as claimed in claim 1, wherein the elastic moldings are based on cellular polyurethane elastomers with density to DIN 53420 of from 200 to 1100 kg/m³, tensile strength to DIN 53571 of ≧2 N/mm², elongation to DIN 53571 of ≧300%, and tear propagation resistance to DIN 53515 of ≧8 N/mm.

5. A spring element as claimed in claim 1, which comprises two elastic moldings of different density to DIN 53420.

6. A spring element as claimed in claim 4, which comprises two moldings differing in each of the parameters given in claim 4.

7. A spring element as claimed in claim 1, wherein the connector is based on compact plastics or metal.

8. A spring element as claimed in claim 1, wherein (i) has height (iv) of 57.5 mm and maximum diameter (v) of 49 mm, (ii) has height (vi) of 40 mm and maximum diameter (vii) of 85 mm, and the entire spring element has height (viii) of from 119 to 123 mm and maximum diameter (ix) of from 84 to 86 mm.

9. An automobile comprising a spring element as claimed in any of claims 1 to 8.
